(19) United States
(12) Patent Application Publication
(10) Pub. No.: US 2014/0172488 A1
(43) Pub. Date: Jun. 19, 2014

(54) SYNTHESIS OF A SCHEDULE REPRESENTATION FROM A PROCESS MODEL

(71) Applicant: THE MITRE CORPORATION, McLean, VA (US)

(72) Inventor: Prem P. JAIN, Reston, VA (US)

(73) Assignee: The MITRE Corporation, McLean, VA (US)

(21) Appl. No.: 13/715,599

(22) Filed: Dec. 14, 2012

(51) Int. Cl. G06Q 10/06

(52) U.S. Cl. CPC G06Q 10/06314
USPC 705/7.22; 705/7.24

(57) ABSTRACT

Synthesizing a schedule representation from a process model includes: defining a process model for a project plan by capturing model parameters and process flow; performing quantitative analysis on the process model, such as, for example, stochastic and queuing analysis; and synthesizing a schedule representation from the process model. In an exemplary embodiment, a discrete event simulation engine is used to synthesize a schedule representation from a process model. In an exemplary embodiment, the synthesized schedule is exported to a project viewer capable of interacting with one or more users. The system and method may include receiving one or more plan change and/or decision inputs, modifying the process model based on such inputs, performing quantitative analysis on the modified process model, and synchronizing the modified process model and the schedule representation.

### STATEMENT REGARDING FEDERALLY-SPONSORED RESEARCH AND DEVELOPMENT

Statement under M.P.E.P. §310. The U.S. government has a paid-up license in this invention and the right in limited circumstances to require the patent owner to license others on reasonable terms as provided for by the terms of contract DHS ICE CCPMO project code 43112013 AA awarded by DHS.

Part of the work performed during development of this invention utilized U.S. Government funds. The U.S. Government has certain rights in this invention.

### BACKGROUND

1. Field

The embodiments described herein relate generally to project management and planning, and more particularly to process modeling and scheduling.

2. Background

Project management relates to the planning, organizing, managing, leading, assigning and controlling of resources in order to meet specific objectives, bring about a specific change, and/or generate value under changing uncertainties while managing project risks and internal and external constraints. A project may have a predefined start and end period and is usually constrained by time, funding, resources, deliverables, and stake-holder interests. A challenge of project management is to achieve project objectives while honoring constraints and adapting to changes during the period of execution. Constraints may include scope, time, quality, resource availability, and/or budget. Project management may further seek to optimize the allocation of inputs, integrate resources, and promote synergy.

Initial project planning may involve the creation and analysis of static flow charts by project managers. Durations of tasks necessary to complete a project may be manually listed and grouped into schedules which represent start and completion times. When a change is introduced to a project plan, schedules need to be updated.

Significant manual effort is required to generate a revised plan and the revised schedule. Such schedule generation is time consuming, error prone, and does not involve a mechanism for incorporating quantitative analysis into decision making for plan changes taking into account plan uncertainties and risk mitigation. Moreover, scheduling involving manual generation and revision of schedules does not scale well to complex, collaborative, and/or multi-stakeholder projects, which frequently involve a high degree of temporal dependencies among stakeholder activities. Process models can aid in capturing and resolving dependencies in complex, collaborative, and multi-stakeholder plans. Process models thus simplify the scheduling complexity caused by high numbers and degrees of dependencies. Process models further offer the benefit of allowing quantitative analysis to be performed on plan uncertainties.

In view of the challenges associated with manual generation and revision of schedules, what is needed is a way to synthesize schedule representations from validated time and resource loaded process models.

### BRIEF SUMMARY

Embodiments described herein include various method, system, and computer program product embodiments, and combinations and sub-combinations thereof, for synthesis of schedule representations from process models.

In an exemplary embodiment, a method for schedule synthesis includes defining a process model from a project plan, performing quantitative analysis on the process model, and synthesizing a schedule representation from the process model.

In an exemplary embodiment, a system for schedule synthesis includes a project planning module configured to define a process model for a project plan. The system also includes a process modeling module configured to perform quantitative what-if analysis on the process model. The system also includes a schedule synthesis module configured to synthesize a schedule representation from a process model.

According to an exemplary embodiment, a computer-readable storage medium has control logic recorded thereon that, when executed by a processor, causes the processor to perform operations to synthesize a schedule. The control logic includes computer-readable program code to cause the processor to perform the operations of defining a process model for a project plan, performing quantitative analysis on the process model, and synthesizing a schedule representation from the process model.

### BRIEF DESCRIPTION OF THE DRAWINGS/FIGURES

The accompanying drawings, which are incorporated herein and form part of the specification, illustrate exemplary embodiments and, together with the description, further serve to explain various underlying principles and enable a person skilled in the relevant art to make and use the invention.

FIG. 1 is an exemplary system for synthesizing schedule representations from process models, in accordance with an embodiment.

FIG. 2 is a more detailed block diagram of the system of FIG. 1, in accordance with an embodiment.

FIG. 3 is a diagram illustrating an exemplary process modeling module and a schedule synthesis module, in accordance with an embodiment.

FIG. 4 is a flowchart illustrating an exemplary method for synthesizing a schedule representation from a process model, in accordance with an embodiment.

FIG. 5 is a flowchart illustrating an exemplary method for receiving change inputs to a process model, in accordance with an embodiment.

FIG. 6 is a diagram illustrating an exemplary computer system, in accordance with an embodiment.

In general, like reference numbers indicate identical and/or functionally similar elements. Additionally, the left-most digit of a reference number identifies the drawing in which the reference number first appears.

### DETAILED DESCRIPTION

The following detailed description refers to the accompanying drawings to illustrate various exemplary embodiments. Various aspects of embodiments described herein can be implemented by computer-readable code, software, firmware, hardware, or any combination thereof. Other embodiments, including any modifications to those described herein, are within the spirit and scope of this disclosure. Any code or syntax used to describe embodiments should not be construed as limiting such embodiments to any particular hardware, firmware, software, or processing device. Any operational behavior associated with a disclosed embodiment is described with the understanding that modifications, variations, and/or adaptions may be possible and that such changes are within the meaning of the disclosed embodiments.

Reference to modules herein refers generally to any combination of hardware components and/or computer-readable code for performing an intended function. A module need not be a rigidly defined entity, such that several modules may overlap hardware and code components in terms of functionality. For example, a module may refer to a single line of code within a procedure, the procedure itself being a separate module. One skilled in the relevant arts will understand that the functionality and/or intended output of a module may be defined, for example, according to a number of stylistic or performance-optimizing techniques, capable of implementation in a variety of forms, all such forms being within the meaning of the disclosed embodiments.

A process model is discussed herein to describe data, systems, and/or methods capable of capturing flow in a project plan. However, the described embodiments are not limited to use of a process model, and the disclosure contemplates any other suitable mechanism for performing analysis on data related to project planning or that may enable analysis of data associated with project planning and/or management. A schedule representation is discussed in order to describe data, system, and/or method embodiments capable of providing a selected deterministic representation of a project plan data based on cost, schedule, uncertainty analysis, and/or resolved dependencies.

System for Synthesizing a Schedule Representation from a Process Model

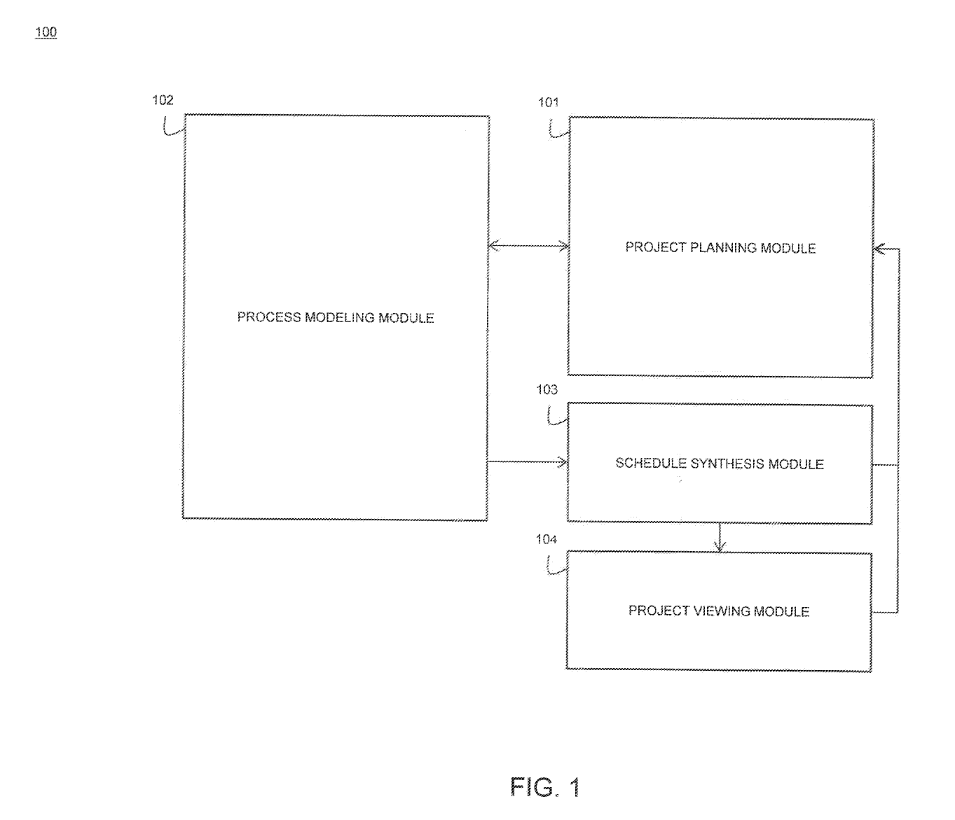

FIG. 1 illustrates an exemplary project management system 100, in accordance with an embodiment. Project management system 100 includes a project planning module 101, a process modeling module 102, a schedule synthesis module 103, and a project viewing module 104. In an exemplary embodiment, project planning module 101 defines a project plan. A project plan includes information, such as, for example, project scope, objectives, external constraints, benchmarks, deliverables, control methods, quality measures, performance measures, monitoring methods, and/or risk tolerances. A project plan may be defined by internal constraints and objectives governed, for example, by one or more stakeholders. A project plan captures potentially conflicting constraints and objectives in order to manage complex, collaborative, and or multi-stakeholder projects involving a high degree of dependencies.

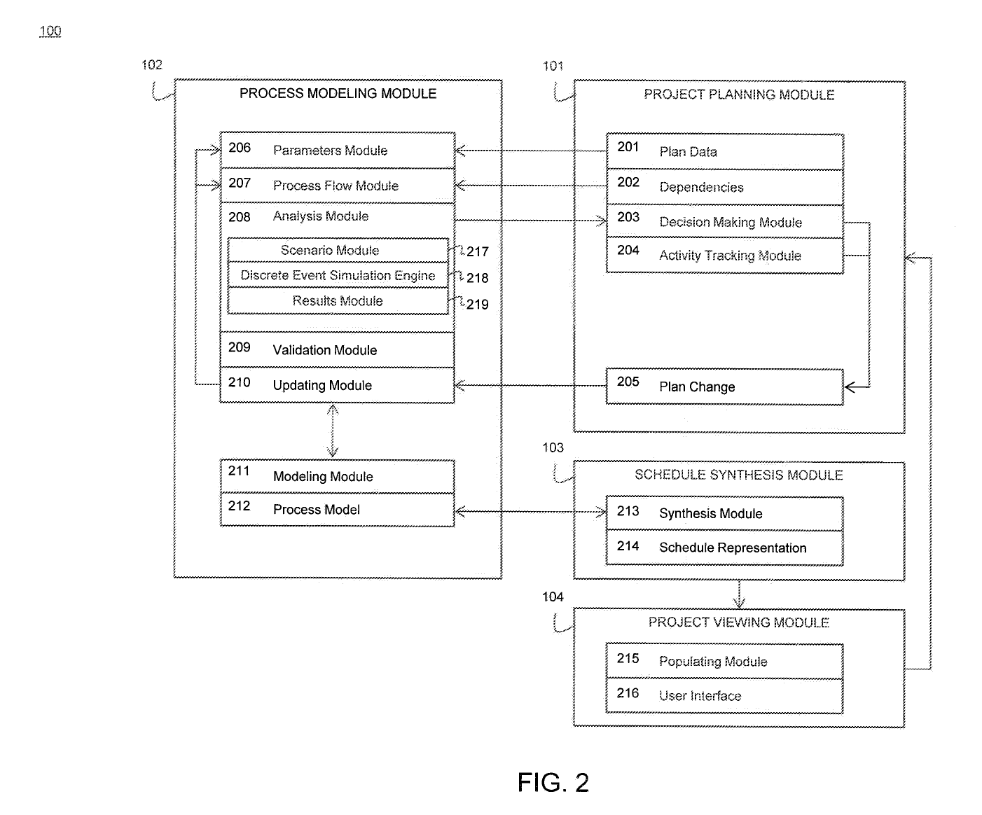

In accordance with an exemplary embodiment illustrated in FIG. 2, data and elements associated with a project plan may be captured by project planning module 101 as plan data 201. Plan data 201 may be comprised of various plan elements. By way of example, not of limitation, an element, such as an activity, may be comprised of various sub-elements, such as, for example, tasks, calculated and/or arranged in sequence to meet a given plan objective, such as, for example, completion of a project deliverable by a due date.

In an exemplary embodiment, data associated with plan data 201 may be imported into and/or received by project planning module 101 in the form of, for example, one or more files, spreadsheets, data structures, process flow charts and/or databases. Input of data associated with plan data 201 is facilitated by a project viewing module 104 configured to receive input from one or more users. Users of project management system 100 interact with a user interface 216 and input information associated with plan data 201. Input to project viewing module 104 is written to one or more files, data structures, tables, spreadsheets, and/or databases by a populating module 215. User interface 216 is configured to display and/or receive input using one or more location independent dashboards, accessible at any node of project management system 100. A dashboard may be implemented as a program, web page, browser plugin, and/or web application. In an exemplary embodiment, a dashboard is customizable and/or location independent.

In an exemplary embodiment, plan data 201 may include data processed by an activity tracking module 204. Activity tracking module 204 receives and monitors input and tracking data from nodes across a network, such as, for example, by receiving and processing data transmitted by project managers, clerks, transaction monitoring systems, and/or resource management systems. Tracking input may be captured by activity tracking module 204 automatically, such as, for example, by synchronizing plan data 201 with systems capable of interfacing with project management system 100. Tracking input may be captured by activity tracking module 204 as input from users interacting with user interface 216.

In accordance with an exemplary embodiment, process modeling module 102 processes plan data 201 as parameters module 206. Parameters module 206 includes one or more measures, values, definitions, and/or factors relating to, for example, cost, resources, capacity, time, budget, constraints, uncertainty, and/or other factors relevant to project planning. Parameters module 206 defines conditions for operation, such as, for example, external or internal constraints, plan specifications supplied by stakeholders, and/or other factors relevant to project planning. Process modeling module 102 binds plan data 201 to one or more data structures and/or elements associated with parameters module 206.

In an exemplary embodiment, project planning module 101 outputs plan data 201 to process modeling module 102. Project planning module 101 notifies process modeling module 102 when plan data 201 changes and/or a plan change 205 occurs. Parameters module 206 is automatically updated to reflect changes to plan data 201 and/or a plan change 205. Process modeling module 102 fetches plan data 201 from project planning module 101, for example, by commanding its retrieval. Process modeling module 102 receives updates regarding changes to plan data 201 which may be processed by an updating module 210. Process modeling module 102 processes and/or tests plan data 201 using a validation module 209.

In an exemplary embodiment, a project plan may capture, define, establish, set and/or manage dependencies, which describe relationships between elements, such as, for example, causal relationships where a change with respect to one element causes a change in another element and/or its operation in a project plan. Dependencies may be captured, for example, for purposes of cost estimation, resource allocation, and/or for optimizing processes such as, for example, by determining optimal timing, workflow, risk, and/or budget management. In an exemplary embodiment, illustrated in FIG. 2, dependencies associated with a project plan may be captured by project planning module 101 as dependencies 202. By way of example, not of limitation, dependencies 202 may be defined as causal, logical, conditional, mandatory, flexible, discretionary, external/internal, and/or may be grouped, ranked, and/or prioritized according to other criteria. By way of example, not limitation, a dependency defined as mandatory may indicate a hard relationship between one or more activities such that, for example, one activity must be completed before another activity can logically and/or physically start. Dependency analysis may thus be used, for example, to determine if, and/or in what sequence, project plan elements can be reordered, parallelized, and/or modified without violating, for example, logical, causal, and/or conditional dependencies.

In an exemplary embodiment, dependencies 202 are encoded and/or recorded in forms, such as, for example, files, executable programs, composite applications, and/or graphical representations, such as, for example, flow charts, flow diagrams, relationship diagramming, and/or dependency notation. Dependencies 202 may be input, loaded into, and/or executed remotely by project planning module 101. Input of dependencies 202 may be facilitated by project viewing module 104. In an exemplary embodiment, project viewing module 104 is configured to receive input from, for example, one or more users interacting with user interface 216. Data associated with dependencies 202 is written to one or more files, data structures, tables, spreadsheets, and/or databases by populating module 215.

In accordance with an exemplary embodiment, process modeling module 102 processes dependencies 202 as process flow module 207. Process flow module 207, for example, may represent the movement, transition, and/or transfer of control from one plan element to another, according to relationships defined by dependencies 202. Process modeling module 102 binds dependencies 202 to one or more data structures and/or elements associated with process flow module 207. Project planning module 101 notifies process modeling module 102 of a change to dependencies 202 and/or a plan change 205. Process flow module 207 is automatically updated to reflect changes in dependencies 202 and/or a plan change 205. Process modeling module 102 fetches dependencies 202 from project planning module 101, for example, by commanding its retrieval. Process modeling module 102 receives updates regarding changes to dependencies 202 which may be processed by an updating module 210. Process modeling module 102 processes and/or tests dependencies 202 using a validation module 209.

In an exemplary embodiment, process modeling module 102 processes and models parameters module 206 and process flow module 207. Process modeling module 102 is configured to capture, process, translate, format, transform, and/or encode associated data in order to generate a process model 212 of parameters module 206 and process flow module 207. Process modeling module 102 includes an analysis module 208, a validation module 209, and/or a modeling module 211. Process modeling module 102 represents parameters module 206 and process flow module 207 in process-level modeling forms, such as, for example, Business Process Modeling Notation (BPMN). Modeling module 211 processes and generates one or more graphical process modeling representations of parameters module 206 and process flow module 207.

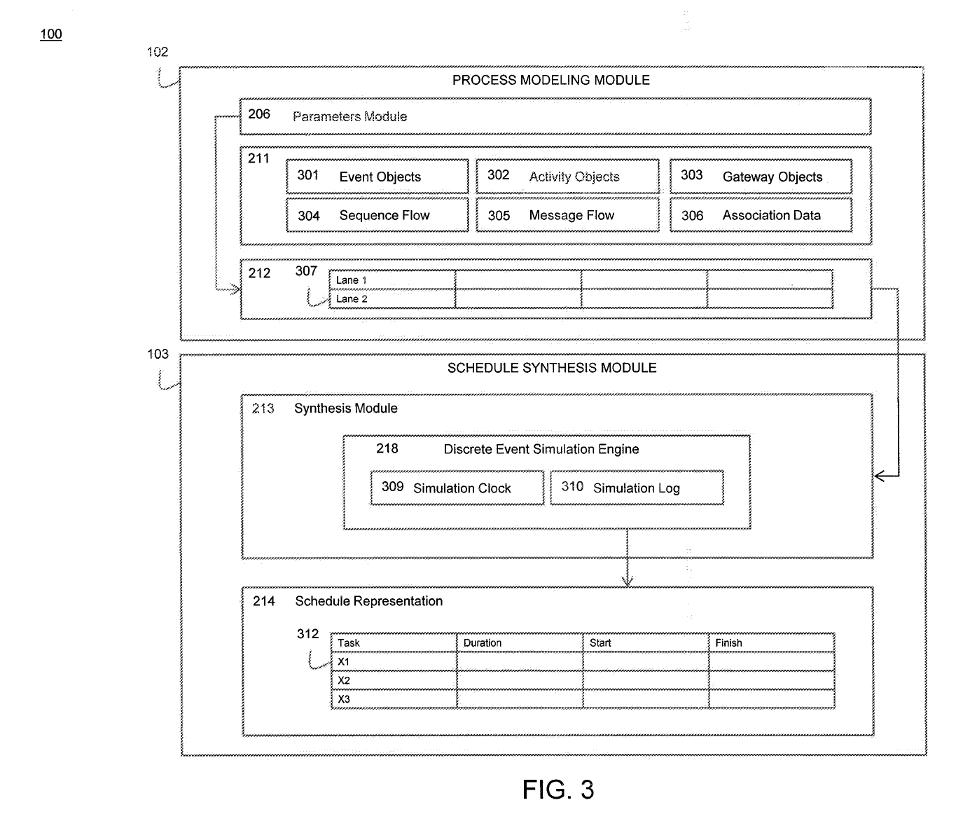

In an exemplary embodiment, modeling module 211 translates and/or models parameters module 206 and process flow module 207 as flow objects and connecting objects, such as, for example, event objects 301, activity objects 302, gateway objects 303, sequence flow 304, message flow 305, and association data 306, illustrated in FIG. 3. Modeling module 211 outputs a process model 212 instantiating flow, parameters, and connection objects generated by modeling module 211, capturing parameters module 206 and process flow module 207. Process model 212 is configured to receive different, modified, updated, adjusted, and/or substitute values associated with parameters module 206.

In an exemplary embodiment, a specific process model 212 is processed using various interchangeable forms and/or multiple instances of parameters module 206.

In an exemplary embodiment, parameters module 206 is customized, industry specific, project specific, dynamic, and/or internally/externally constrained by one or more stakeholders. Parameters module 206 is interchangeable with, compatible with, and/or substitutable with any data capable of being modeled as parameters.

In an exemplary embodiment, event object 301 represents the occurrence of an event, such as, for example, a trigger, message, and/or result etc. Activity object 302 represents a type of activity, such as, for example, a task, sub-process, transaction, and/or call activity etc. In an exemplary embodiment, gateway object 303 represents branching, forking, and/or merging of process paths.

According to an exemplary embodiment, gateway objects 303 depend on conditions, criteria, and/or relationships defined by parameters module 206 and process flow module 207. Gateway objects 303 represent alternative flows, parallel paths, and/or synchronization behavior etc.

In an exemplary embodiment, sequence flow 304 represents the time order in which activity objects 302 are performed. Sequence flow 304 reflects causal dependencies defined by process flow module 207, such that, for example, hard dependencies dictate sequence flow 304. Sequence flow 304 may be conditional, such that, for example, flow proceeds if and only if stated conditions are met or else, for example, an alternative default flow proceeds. In an exemplary embodiment, message flow 305 represents the flow of messages across, for example, organizational boundaries. Organizational boundaries may be represented as pools, such pools being divisible into one or more lanes. In an exemplary embodiment, activity objects 302 within a pool correspond to functions, roles, and/or operations within an organization. A lane may contain flow objects. In an exemplary embodiment, process model 212 may take the form of a graphical process modeling representation, including, for example, visual elements such as a swim lane diagram 307, illustrated in FIG. 3.

In accordance with an exemplary embodiment, association data 306 represents relationships between data, text, artifacts, and/or flow objects in a process model 212. Association data 306 reflects relationships and/or dependencies, such as, for example, those captured by parameters module 206 and/or process flow module 207. Association data 306 may represent directional association or non-directional association. By way of example, not limitation, non-directional association data 306 may be appropriate in an instance where sequence flow 304 and/or message flow 305 already indicate directionality.

In an exemplary embodiment, analysis module 208 analyzes parameters module 206, process flow module 207, and/or process model 212. Analysis module 208 is configured to perform one or more types of quantitative analyses on parameters module 206, process flow module 207, and/or process model 212, including but not limited to queuing and/or stochastic analysis. Analysis module 208 executes one or more standard and/or custom programs configured to perform analyses on parameters module 206, process flow module 207, and/or process model 212, including, for example, simulation, estimation, forecasting, resource modeling, time modeling, workload modeling, uncertainty modeling, risk assessment, mission level modeling (MLM), measure of effectiveness (MOE) modeling, measure of performance (MOP) modeling, and/or any analysis relevant to project planning.

In an exemplary embodiment, analysis module 208 includes a scenario module 217, a discrete event simulation engine 218, and a results module 219. Scenario module 217 generates execution scenarios using known, theoretical, and/or estimated plan data, dependencies, constraints, and resources. Scenario module 217 may take into account variables, uncertainty, risk, and any factor relevant to decision making.

In an exemplary embodiment, discrete event simulation engine 218 processes outputs from scenario module 217, such as, execution scenarios, and simulates event sequences using standard and/or custom programs configured to perform analysis on such execution scenarios, parameters module 206, process flow module 207, and/or process model 212. Discrete event simulation engine 218 outputs results of simulation analysis to results module 219. Results module 219 processes and provides analyzed output to project planning module 101.

In an exemplary embodiment, analysis module 208 performs queuing and/or stochastic analysis on parameters module 206, process flow module 207, and/or process model 212. Analysis module 208 generates data for decision making such as one or more alternate project plans and/or proposed changes to the project plan reflecting plan optimization. Analysis module 208 stores alternate project plans and/or proposed changes to the project plan for processing by schedule synthesis module 103. Analysis module 208 exports alternate project plans and/or proposed changes to the project plan to a user interface, such as, for example, user interface 216 for review and/or consideration by users, such as, for example, a project manager.

In an exemplary embodiment, a decision making module 203, associated with project planning module 101, is configured to receive inputs from a user, such as, for example, a project manager or authorized user of project management system 100. Decision making module 203 receives such decision inputs from a user, system, and/or an authorized node. Decision making module 203 processes decision inputs and notifies an updating module 210 associated with process modeling module 102. Updating module 210 causes updates, such as plan change 205, resulting from a project management decision, to propagate through process modeling module 102 and modify affected values associated with parameters module 206 and process flow module 207. Decision making module 203 receives analyzed outputs from analysis module 208 such as, for example, analyzed outputs processed by scenario module 217, discrete event simulation engine 218, and results module 219.

In accordance with an exemplary embodiment, activity tracking module 204 is configured to receive inputs from a user and/or interfacing tracking system, such as, for example, a clerk, monitoring system, resource management system, and/or other source of project management or tracking data. Activity tracking module 204 provides one or more tracking inputs to updating module 210. Updating module 210 causes updates, such as those resulting from activity changes, to propagate through process modeling module 102 and modify affected values associated with parameters module 206 and process flow module 207. Plan change 205 reflects input from a user, such as, for example, from user interface 216 and/or an interfacing planning system. Updating module 210 causes updates, such as those resulting from a plan change 205, to propagate through process modeling module 102 and to modify affected values associated with parameters module 206 and process flow module 207.

In an exemplary embodiment, updates processed by updating module 210 may be validated according to criteria defined by a validation module 209. Validation module 209 is configured to accept, reject, and/or selectively apply updates. Prior to propagating updates throughout process modeling module 102, validation module 209 checks inputs against one or more specifications defining acceptable input formats. Validation module 209 tests the compatibility of inputs with process model 212 prior to propagating updates throughout process modeling module 102. Validation module 209 commands analysis module 208 to analyze change and/or decision inputs. Analysis module 208 generates one or more alternate changes and/or decisions reflecting plan optimization. Such alternate changes and/or decisions are provided to user interface 216 for consideration by, for example, a project manager. Where inputs provided to updating module 210 by decision making module 203 violate constraints of parameters module 206 and/or process flow module 207, validation module 209 outputs notification of such violation and/or generates a substantive and/or narrative explanation for the user regarding the nature and/or magnitude of the determined conflict.

In an exemplary embodiment, upon execution of an analysis cycle by analysis module 208, modeling module 211 generates an updated process-level representation of parameters module 206 and process flow module 207 as process model 212. Referring to FIG. 3, process model 212 instantiates flow objects and connecting objects generated by modeling module 211, such as, for example, event objects 301, activity objects 302, gateway objects 303, sequence flow 304, message flow 305, and association data 306.

In an exemplary embodiment, process model 212 is displayed as a graphical modeling representation comprised of visual elements associated with Business Process Modeling Notation. In an exemplary embodiment, a graphical modeling representation includes a swim lane diagram 307, illustrated in FIG. 3. Modeling module 211 generates process model 212 as computer-readable code.

According to an embodiment, a schedule synthesis module 103 is configured to synthesize a schedule representation 214 from process model 212. A synthesis module 213 transforms process model 212 into schedule representation 214 using a discrete event simulation engine 218. The synthesis of schedule representation 214 reconciles constraints and criteria associated with parameters module 206 and/or resolves dependencies associated with process flow module 207. Transformation of process model 212 to schedule representation 214 occurs after one or more analysis cycles by analysis module 208. Synthesized schedule representation 214 incorporates plan changes and decision inputs provided to updating module 210. Schedule representation 214 comprises a graphical table of start and completion times grouped by task, such as, for example, time table 312.

According to an exemplary embodiment, synthesis module 213 automatically synthesizes schedule representation 214 from process model 212 using a discrete event simulation engine 218. By way of example, not of limitation, discrete event simulation engine 218 causes representation of process model 212 as a chronological sequence of discrete events, each associated with a date and/or time. Discrete event simulation engine 218 resolves dependencies dynamically according to flow objects and connecting objects represented in process model 212, such as, for example, event objects 301, activity objects 302, gateway objects 303, sequence flow 304, message flow 305, and association data 306. Discrete event simulation engine 218 synthesizes schedule representation 214 by: initializing flow objects and connecting objects associated with process model 212; initializing a simulation clock 309; simulating implementation of objects represented in process model 212, for example, by simulating implementation of event objects 301, activity objects 302, gateway objects 303, sequence flow 304, message flow 305, and association data 306; plotting resolved corresponding start and completion time values for tasks to a simulation log 310; and generating a schedule representation 214.

In an exemplary embodiment, discrete event simulation engine 218 maintains simulation clock 309 as a measure of virtual time. By way of example, not limitation, discrete event simulation engine 218 associates timestamps with flow objects, such as, for example, event objects 301. Discrete event simulation engine 218 resolves dependencies and constraints in accordance with the flow objects and connecting objects defined in process model 212 for a particular plan implementation. Discrete event simulation engine 218 processes, organizes, and queues resolved flow objects. Discrete event simulation engine 218 extracts flow objects determining dynamically the schedule for implementation. In an exemplary embodiment, discrete event simulation engine 218 provides resolved corresponding start and completion time values to simulation log 310. Discrete event simulation engine 218 binds simulation log 310 to schedule representation 214. A graphical and/or listed time table 312 displays schedule representation 214 as a deterministic representation of a project plan implementation defined by process model 212.

In an exemplary embodiment, schedule representation 214 may be exported to project viewing module 104. Schedule representation 214 takes the form a deterministic time table 312 displayed to a user interacting with user interface 216. User interface 216 is configured to display and/or receive scheduling input through one or more location independent dashboards, accessible at any node connected to project management system 100. A dashboard may be implemented as a software program, web page, browser plugin, and/or web application configured to display an intuitive graphical schedule representation 214, such as time table 312, and/or any data derived from schedule representation 214. User interface 216 receives and transmits scheduling inputs provided by a user, such as, for example, a project manager, through interaction with schedule representation 214 as displayed by user interface 216. Interaction with schedule representation 214 causes updating module 210 to propagate scheduling inputs through process modeling module 102 and modify affected values associated with parameters module 206 and process flow module 207.

In accordance with an exemplary embodiment, a schedule synthesis module 103 causes synchronization of process model 212 and schedule representation 214. Schedule synthesis module 103 maintains real-time synchronization of process model 212 and schedule representation 214. Synchronization follows an analysis cycle or propagation of an update through process modeling module 102 by updating module 210. Schedule synthesis module 103 synchronizes process model 212 and schedule representation 214 upon notification of an update to parameters module 206 and/or process flow module 207. Schedule synthesis module 103 synchronizes process model 212 and schedule representation 214 upon user selection of an alternate project plan, and/or a proposed change, output by analysis module 208.

Method for Synthesizing a Schedule Representation from a Process Model

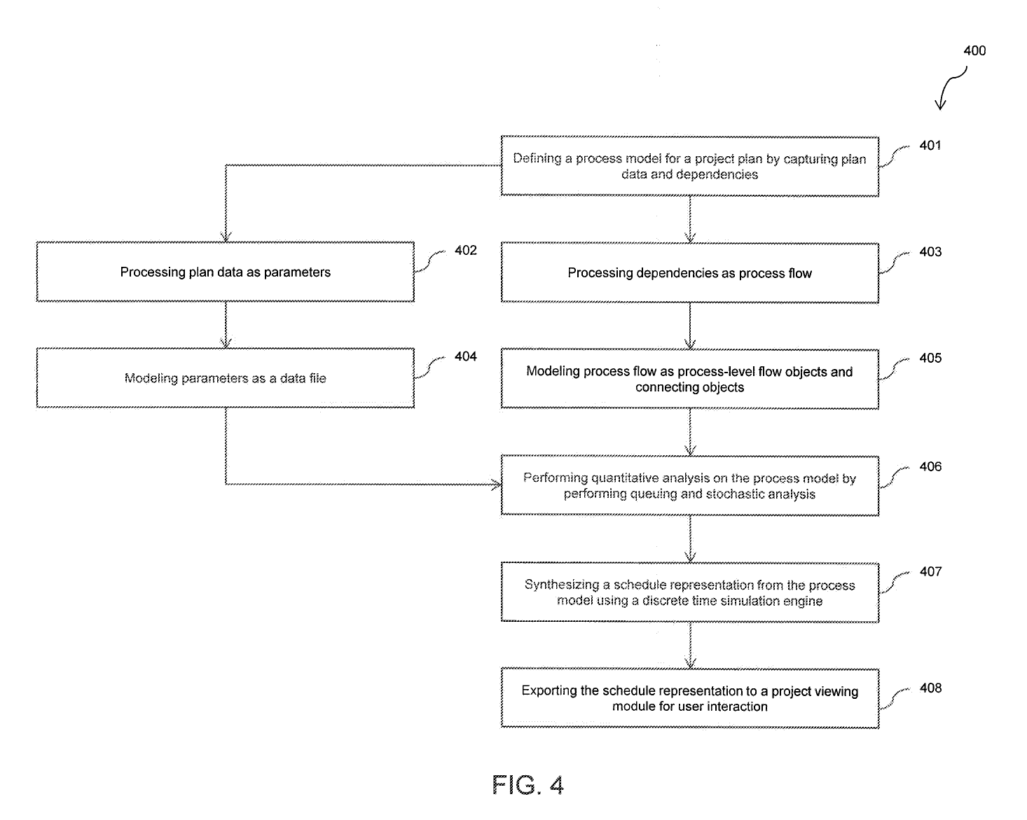

FIG. 4 is a flow diagram illustrating a method 400 for synthesizing a schedule representation from a process model, in accordance with an embodiment.

Method 400 begins at step 401, where a process model is defined for a project plan by capturing plan data and dependencies.

In step 401, project planning module 101 captures plan data 201 and dependencies 202. Data associated with plan data 201 may be imported into and/or received by project planning module 101 in the form of, for example, one or more data files, spreadsheets, data structures, and/or databases. Input of information associated with plan data 201 may be facilitated by project viewing module 104, configured to receive input from one or more users. Embodiment, users of project management system 100 interact with user interface 216 and input information associated with plan data 201. Input to project viewing module 104 is written to one or more files, tables, spreadsheets, data structures, and/or databases by populating module 215. User interface 216 is configured to display and/or receive input using one or more location independent dashboards, accessible at any node of project management system 100.

In an exemplary embodiment, plan data 201 may also include data processed by activity tracking module 204. Activity tracking module 204 receives and monitors input and tracking data from nodes across a network, such as, for example, by receiving and processing data transmitted by project managers, clerks, transaction monitoring systems, and/or resource management systems. Tracking input may be captured by activity tracking module 204 automatically, such as, for example, by synchronizing plan data 201 with systems capable of interfacing with project management system 100. Tracking input may be captured by activity tracking module 204 as input from users interacting with user interface 216.

In an exemplary embodiment, dependencies 202 may be input, loaded into, and/or executed remotely by project planning module 101. Input of dependencies 202 may be facilitated by project viewing module 104. Project viewing module 104 is configured to receive input from, for example, one or more users interacting with user interface 216. Data associated with dependencies 202 is written to one or more files, data structures, tables, spreadsheets, and/or databases by populating module 215.

At step 402, plan data is processed as parameters.

In accordance with an exemplary embodiment, in step 402, process modeling module 102 processes plan data 201 as parameters module 206. Process modeling module 102 binds plan data 201 to one or more data structures and/or elements associated with parameters module 206. Project planning module 101 notifies process modeling module 102 of a change to plan data 201 and/or a plan change 205. Parameters module 206 is automatically updated to reflect changes in plan data 201 and/or a plan change 205.

In an exemplary embodiment, process modeling module 102 fetches plan data 201 from project planning module 101, for example, by commanding its retrieval. Process modeling module 102 receives updates regarding changes to plan data 201 which may be processed by an updating module 210. Process modeling module 102 processes and/or tests plan data 201 using validation module 209.

At step 403, dependencies are processed as process flow.

In accordance with an exemplary embodiment, in step 403, process modeling module 102 processes dependencies 202 as process flow module 207. Process modeling module 102 binds dependencies 202 to one or more data structures and/or elements associated with process flow module 207. Project planning module 101 notifies process modeling module 102 of a change to dependencies 202 and/or a plan change 205. Process flow module 207 is automatically updated to reflect changes in dependencies 202 and/or a plan change 205.

In an exemplary embodiment, process modeling module 102 fetches dependencies 202 from project planning module 101, for example, by commanding its retrieval. Process modeling module 102 receives updates regarding changes to dependencies 202 which may be processed by an updating module 210. Process modeling module 102 processes and/or tests dependencies 202 using validation module 209.

At step 404, parameters are modeled as a data file.

In an exemplary embodiment, in step 404, parameters module 206 defines conditions for operation, such as, for example, external or internal constraints, plan specifications supplied by stakeholders, and/or other factors relevant to project planning. Process modeling module 102 binds plan data 201 to one or more data structures and/or elements associated with parameters module 206 capable of being modeled and/or output as, for example, a data file.

At step 405, process flow is modeled as process-level flow objects and connecting objects.

In an exemplary embodiment, in step 405, process modeling module 102 processes and models process flow module 207. Process modeling module 102 is configured to capture, process, translate, format, transform, and/or encode associated data in order to generate process model 212 of process flow module 207. Process modeling module 102 represents process flow module 207 in process-level modeling forms, such as, for example, Business Process Modeling Notation (BPMN).

In an exemplary embodiment, modeling module 211 processes and generates one or more graphical process modeling representations of parameters module 206 and process flow module 207. Modeling module 211 translates and/or models parameters module 206 and process flow module 207 as flow objects and connecting objects, such as, for example, event objects 301, activity objects 302, gateway objects 303, sequence flow 304, message flow 305, and association data 306. Modeling module 211 generates process model 212, capturing parameters module 206 and process flow module 207 as flow and connection objects.

At step 406, quantitative analysis is performed on a process model.

In an exemplary embodiment, in step 406, analysis module 208 analyzes parameters module 206, process flow module 207, and/or process model 212. Analysis module 208 is configured to perform one or more types of quantitative analyses on parameters module 206, process flow module 207, and/or process model 212, including but not limited to queuing and/or stochastic analysis. Analysis module 208 executes one or more standard and/or custom programs configured to perform analyses on parameters module 206, process flow module 207, and/or process model 212, including, for example, simulation, estimation, forecasting, resource modeling, time modeling, workload modeling, uncertainty modeling, risk assessment, mission level modeling (MLM), measure of effectiveness (MOE) modeling, measure of performance (MOP) modeling, and/or any analysis relevant to project planning.

In an exemplary embodiment, discrete event simulation engine 218 performs analysis using outputs from scenario module 217 and simulates event sequences using standard and/or custom programs configured to perform analysis on such execution scenarios, parameters module 206, process flow module 207, and/or process model 212. Discrete event simulation engine 218 outputs results of simulation analysis to results module 219. Results module 219 processes and provides analyzed output to project planning module 101.

In an exemplary embodiment, a decision making module 203, associated with project planning module 101, is configured to receive inputs from a user, such as, for example, a project manager. Decision making module 203 is configured to receive analyzed outputs from analysis module 208 for consideration by a project manager capable of providing decision inputs, for example, in response to analyzed outputs processed by scenario module 217, discrete event simulation engine 218, and results module 219. Analyzed outputs are presented for consideration using any information display, representation, and/or user interface, such as, for example, user interface 216.

In an exemplary embodiment, analysis module 208 performs queuing and/or stochastic analysis on parameters module 206, process flow module 207, and/or process model 212. Analysis module 208 generates data for decision making, such as, one or more alternate project plans and/or proposed changes to the project plan reflecting optimization. Analysis module 208 stores alternate project plans and/or proposed changes to the project plan for processing by schedule synthesis module 103. Analysis module 208 exports alternate project plans and/or proposed changes to the project plan to a user interface, such as, for example, user interface 216 for review and/or consideration by users, such as, for example, a project manager. Process model 212 is configured to receive different, modified, updated, adjusted, and/or substitute values associated with parameters module 206.

In an exemplary embodiment, a specific process model 212 is processed using various interchangeable forms and/or multiple instances of parameters module 206. In an exemplary embodiment, upon execution of an analysis cycle by analysis module 208, modeling module 211 generates an updated process-level representation of parameters module 206 and process flow module 207 as process model 212.

At step 407, a schedule representation is synthesized from a process model using a discrete event simulation engine.

According to an embodiment, in step 407, a schedule synthesis module 103 is configured to synthesize a schedule representation 214 from process model 212. A synthesis module 213 transforms process model 212 into schedule representation 214 using a discrete event simulation engine 218. The synthesis of schedule representation 214 reconciles constraints and criteria associated with parameters module 206 and/or resolves dependencies associated with process flow module 207. Transformation of process model 212 to schedule representation 214 occurs after one or more analysis cycles by analysis module 208. Synthesized schedule representation 214 incorporates plan changes and decision inputs provided to updating module 210. Schedule representation 214 comprises a graphical table of start and completion times grouped by task, such as, for example, time table 312.

According to an exemplary embodiment, synthesis module 213 automatically synthesizes schedule representation 214 from process model 212 using a discrete event simulation engine 218. By way of example, not of limitation, discrete event simulation engine 218 causes representation of process model 212 as a chronological sequence of discrete events, each associated with a date and/or time. Discrete event simulation engine 218 resolves dependencies dynamically according to flow objects and connecting objects represented in process model 212, such as, for example, event objects 301, activity objects 302, gateway objects 303, sequence flow 304, message flow 305, and association data 306. Discrete event simulation engine 218 synthesizes schedule representation 214 by, for example: initializing flow objects and connecting objects associated with process model 212; initializing a simulation clock 309; simulating implementation of objects represented in process model 212, for example, by simulating implementation of event objects 301, activity objects 302, gateway objects 303, sequence flow 304, message flow 305, and association data 306; plotting resolved corresponding start and completion time values to a simulation log 310; and generating a schedule representation 214.

In an exemplary embodiment, discrete event simulation engine 218 maintains simulation clock 309 as a measure of virtual time. By way of example, not limitation, discrete event simulation engine 218 associates timestamps with flow objects, such as, for example, event objects 301. Discrete event simulation engine 218 resolves dependencies and constraints in accordance with the flow objects and connecting objects defined in process model 212 for a particular plan implementation. Discrete event simulation engine 218 processes, organizes, and queues resolved flow objects. Discrete event simulation engine 218 extracts flow objects determining the schedule for implementation. Discrete event simulation engine 218 provides corresponding start and completion time values to simulation log 310. Discrete event simulation engine 218 binds simulation log 310 to schedule representation 214. In an exemplary embodiment, a graphical and/or list representation, such as, for example, time table 312, displays schedule representation 214 as a deterministic implementation defined by parameters module 206, process flow module 207, and/or process model 212.

At step 408, a schedule representation is exported to a project viewing module for user interaction.

In an exemplary embodiment, in step 408, schedule representation 214 is exported to project viewing module 104. Schedule representation 214 takes the form a deterministic time table 312 displayed to a user interacting with user interface 216. User interface 216 is configured to display and/or receive scheduling input through one or more location independent dashboards, accessible at any node connected to project management system 100. A dashboard may be implemented as a software program, web page, browser plugin, and/or web application configured to display an intuitive graphical schedule representation 214, such as time table 312, and/or any data derived from schedule representation 214. User interface 216 receives and transmits scheduling inputs provided by a user, such as, for example, a project manager, through interaction with schedule representation 214 as displayed by user interface 216. Interaction with schedule representation 214 causes updating module 210 to propagate scheduling inputs through process modeling module 102 and modify affected values associated with parameters module 206 and process flow module 207.

### Method for Synchronizing Modified Process Model and Schedule Representation

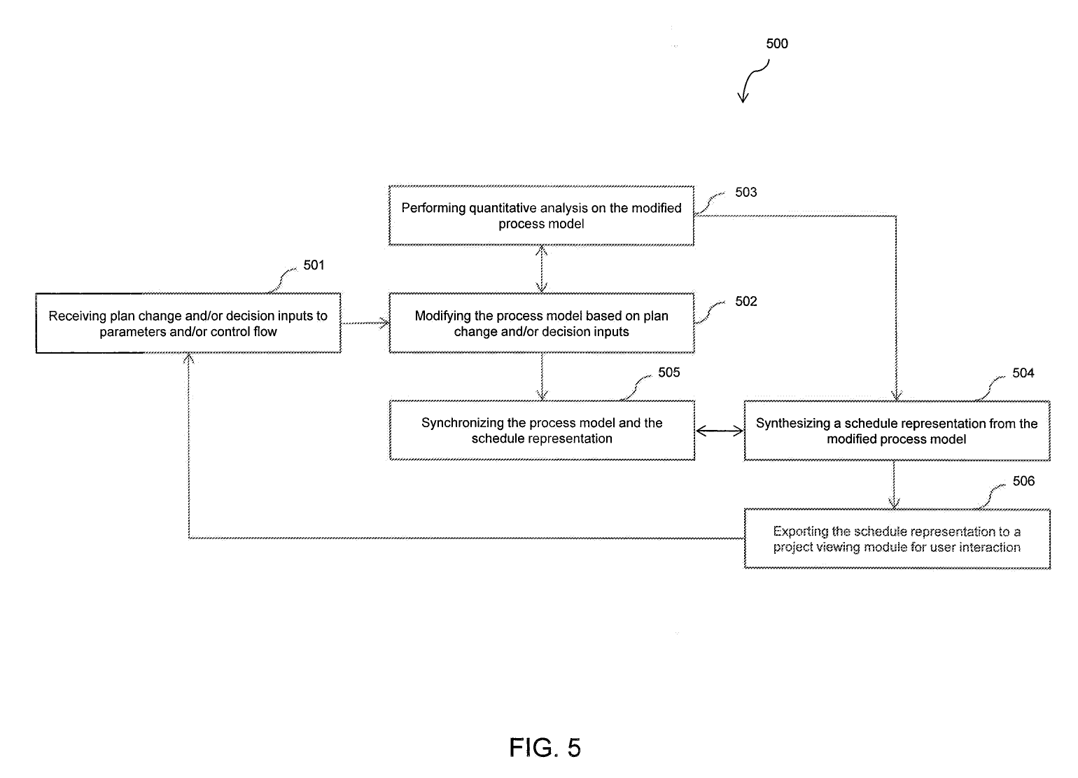

FIG. 5 is a flow diagram illustrating an exemplary method for receiving and processing change inputs, in accordance with an embodiment.

Method 500 begins at step 501, when plan change and/or decision inputs are received for modifying parameters and/or process flow.

In an exemplary embodiment, in step 501, project planning module 101 outputs plan data 201 to process modeling module 102 to be processed as parameters module 206. Project planning module 101 notifies process modeling module 102 when plan data 201 changes and/or a plan change 205 occurs. In an exemplary embodiment, parameters module 206 is automatically updated to reflect changes to plan data 201 and/or a plan change 205. Process modeling module 102 fetches plan data 201 from project planning module 101, for example, by commanding its retrieval. Process modeling module 102 receives updates regarding changes to plan data 201 which may be processed by updating module 210. Process modeling module 102 tests plan data 201 using validation module 209.

In accordance with an exemplary embodiment, project planning module 101 outputs dependencies 202 to process modeling module 102 to be processed as process flow module 207. Process modeling module 102 binds dependencies 202 to one or more data structures and/or elements associated with process flow module 207. Project planning module 101 notifies process modeling module 102 of a change to dependencies 202 and/or a plan change 205. Process flow module 207 is automatically updated to reflect changes in dependencies 202 and/or a plan change 205. Process modeling module 102 fetches dependencies 202 from project planning module 101, for example, by commanding its retrieval. Process modeling module 102 receives updates regarding changes to dependencies 202, which may be processed by updating module 210. Process modeling module 102 tests dependencies 202 using validation module 209. A decision making module 203, associated with project planning module 101, is configured to receive inputs from a user, such as, for example, a project manager or user of project management system 100.

In accordance with an exemplary embodiment, decision making module 203 receives such decision inputs from a user, system, and/or an authorized node. In an exemplary embodiment, decision making module 203 processes decision inputs and notifies updating module 210 associated with process modeling module 102.

In accordance with an exemplary embodiment, activity tracking module 204 is configured to receive inputs from a user and/or interfacing tracking system, such as, for example, a clerk, monitoring system, resource management system, and/or other source of project management or tracking data. In an exemplary embodiment, activity tracking module 204 provides one or more tracking inputs to updating module 210.

At step 502, a process model is modified based on plan change and/or decision inputs.

In an exemplary embodiment, in step 502, updating module 210 causes updates, such as plan change 205, resulting from a project management decision, to propagate through process modeling module 102 and modify affected values associated with parameters module 206 and process flow module 207. Updating module 210 causes updates to propagate through process modeling module 102 and modify affected values associated with parameters module 206 and process flow module 207. Plan change 205 reflects input from a user, for example, from user interface 216 and/or an interfacing planning system. Updating module 210 causes updates, such as those resulting from a plan change 205 and/or decision input, to propagate through process modeling module 102 and to modify affected values associated with parameters module 206 and process flow module 207.

In an exemplary embodiment, updates processed by updating module 210 may be validated according to criteria defined by a validation module 209. Validation module 209 is configured to accept, reject, and/or selectively apply updates. Prior to propagating updates throughout process modeling module 102, validation module 209 checks inputs against one or more specifications defining acceptable input formats. Validation module 209 tests the compatibility of inputs with process model 212 prior to propagating updates throughout process modeling module 102.

At step 503, quantitative analysis is performed on a modified process model.

In an exemplary embodiment, in step 503, analysis module 208 performs queuing and/or stochastic analysis on modified parameters module 206, process flow module 207, and/or process model 212. Analysis module 208 generates one or more alternate project plans and/or proposed changes to the project plan reflecting model optimization. Analysis module 208 stores alternate project plans and/or proposed changes to the project plan for processing by schedule synthesis module 103. Analysis module 208 exports alternate project plans and/or proposed changes to the project plan to a user interface, such as, for example, user interface 216 for review and/or consideration by users, such as, for example, a project manager.

According to an exemplary embodiment, validation module 209 commands analysis module 208 to analyze plan change and/or decision inputs. Analysis module 208 generates one or more alternate changes and/or decisions reflecting optimization. Alternate changes and/or decisions are provided to user interface 216 for consideration by, for example, a project manager. Upon user selection of an alternate project plan, and/or proposed change to a project plan, analysis module, updating module 210 causes updates, such as those resulting from such user selection of an alternate project plan, and/or proposed change, to propagate through process modeling module 102 and to modify affected values associated with parameters module 206 and process flow module 207, for example, as described at step 502.

In an exemplary embodiment, upon execution of an analysis cycle by analysis module 208, modeling module 211 generates an updated process-level representation of parameters module 206 and process flow module 207 as process model 212.

At step 504, a schedule representation is synthesized from a modified process model.

According to an embodiment, in step 504, a schedule synthesis module 103 is configured to synthesize a schedule representation 214 from modified process model 212. Synthesis module 213 transforms modified process model 212 into schedule representation 214 using a discrete event simulation engine 218. Synthesis of schedule representation 214 reconciles constraints and criteria associated with parameters module 206 and/or resolves dependencies associated with process flow module 207. Transformation of modified process model 212 to schedule representation 214 occurs after one or more analysis cycles by analysis module 208. Synthesized schedule representation 214 incorporates plan changes and decision inputs provided to updating module 210. In an exemplary embodiment, schedule representation 214 comprises a graphical table of start and completion times grouped by task, such as, for example, time table 312.

In an exemplary embodiment, synthesis module 213 automatically synthesizes schedule representation 214 from modified process model 212 using a discrete event simulation engine 218. By way of a non-limiting example, discrete event simulation engine 218 causes representation of modified process model 212 as a chronological sequence of discrete events, each associated with a date and/or time. Discrete event simulation engine 218 resolves dependencies dynamically according to flow and connecting objects represented in modified process model 212, such as, for example, event objects 301, activity objects 302, gateway objects 303, sequence flow 304, message flow 305, and association data 306. Discrete event simulation engine 218 synthesizes schedule representation 214 by, for example: initializing flow objects and connecting objects associated with modified process model 212; initializing a simulation clock 309; simulating implementation of objects represented in modified process model 212, for example, by simulating implementation of modified event objects 301, activity objects 302, gateway objects 303, sequence flow 304, message flow 305, and association data 306; plotting corresponding start and completion time values to a simulation log 310; and generating a schedule representation 214.

In an exemplary embodiment, discrete event simulation engine 218 maintains simulation clock 309 as a measure of virtual time. By way of example, not limitation, discrete event simulation engine 218 associates timestamps with flow objects, such as, for example, event objects 301. Discrete event simulation engine 218 resolves dependencies and constraints in accordance with the flow objects and connecting objects defined in modified process model 212 for the modified plan implementation. Discrete event simulation engine 218 processes, organizes, and queues resolved flow objects. In an exemplary embodiment, discrete event simulation engine 218 extracts flow objects determining the schedule for implementation. Discrete event simulation engine 218 provides corresponding start and completion time values to simulation log 310. Discrete event simulation engine 218 binds simulation log 310 to schedule representation 214. In accordance with an exemplary embodiment, a graphical and/or list representation, such as, for example, time table 312 displays schedule representation 214 as a deterministic implementation defined by modified parameters module 206, process flow module 207, and/or process model 212.

At step 505, a process model and a schedule representation are synchronized.

In an exemplary embodiment, in step 505, synchronization of process model 212 and schedule representation 214 is maintained by synthesizing updates to, for example, values associated with parameters module 206 and/or process flow module 207. Updates are synchronized upon processing by updating module 210 and/or validation module 209. Inputs from one or more systems interfacing with project management system 100 are synchronized using discrete event simulation engine 218 to synthesize an updated schedule representation 214 from any updates to parameters module 206 and/or process flow module 207.

In accordance with an exemplary embodiment, a schedule synthesis module 103 causes synchronization of process model 212 and schedule representation 214. Schedule synthesis module 103 maintains real-time synchronization of process model 212 and schedule representation 214. Synchronization follows an analysis cycle or propagation of an update through process modeling module 102 by updating module 210. Schedule synthesis module 103 synchronizes process model 212 and schedule representation 214 upon notification of an update to parameters module 206 and/or process flow module 207. Schedule synthesis module 103 synchronizes process model 212 and schedule representation 214 upon user selection of an alternate project plan, and/or proposed change to a project plan, output by analysis module 208 to reflect optimization.

At step 506, a schedule representation is exported to a project viewing module for user interaction.

In accordance with an exemplary embodiment, in step 506, schedule representation 214 is exported to project viewing module 104. In an exemplary embodiment, schedule representation 214 takes the form a deterministic time table 312 displayed to a user interacting with user interface 216. User interface 216 is configured to display and/or receive scheduling input through one or more location independent dashboards, accessible at any node connected to project management system 100. User interface 216 receives and transmits scheduling inputs provided by a user, such as, for example, a project manager, through interaction with schedule representation 214 as displayed by user interface 216. Interaction with schedule representation 214 causes updating module 210 to propagate scheduling inputs through process modeling module 102 and modify affected values associated with parameters module 206 and process flow module 207.

In an exemplary embodiment, user input to project viewing module 104 results in iterations of method 500.

### Example Computer System

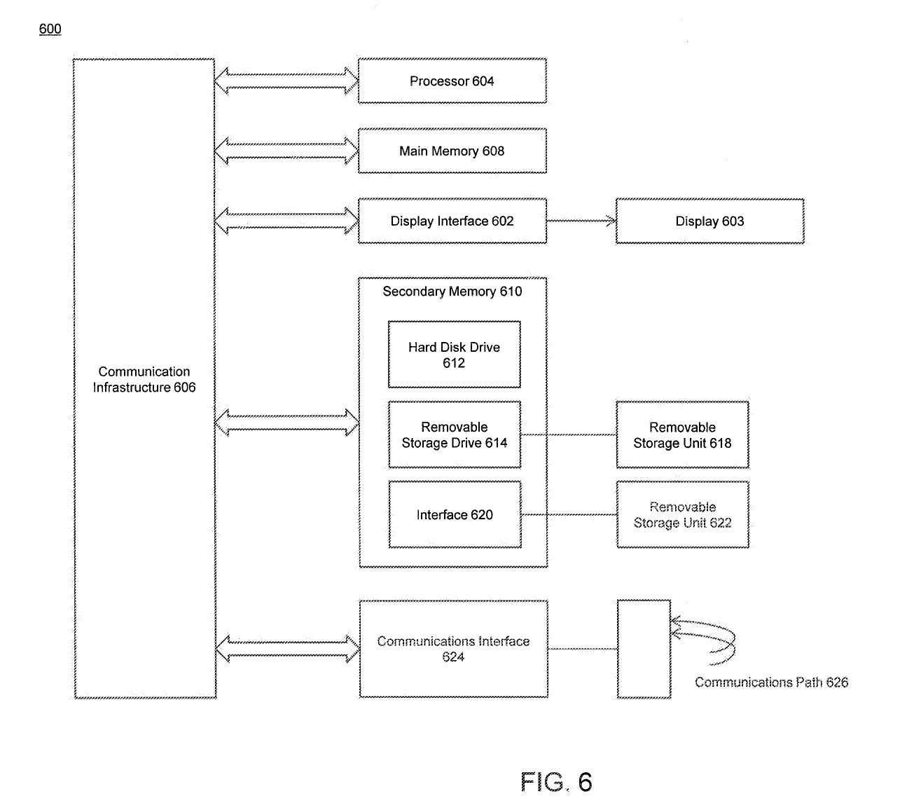

In an exemplary embodiment, the system and components of embodiments described herein are implemented using one or more computer systems, such as, for example, computer system 600, shown in FIG. 6.

Computer system 600 includes one or more processors (also called central processing units, or CPUs), such as a processor 604. Processor 604 is connected to a communication infrastructure 606. Computer system 600 also includes a main or primary memory 608, such as random access memory (RAM). Main memory 608 has stored control logic (computer software), and data.

Computer system 600 may also include one or more secondary storage devices 610. Secondary storage device 610 includes, for example, a hard disk drive 612 and/or a removable storage device or drive 614, as well as other types of storage devices, such as memory cards and memory sticks. Removable storage drive 614 represents a floppy disk drive, a magnetic tape drive, a compact disk drive, an optical storage device, tape backup, etc. Removable storage drive 614 may interact with a removable storage unit 618. Removable storage unit 618 includes a computer usable or readable storage device having stored thereon computer software (control logic) and/or data. Removable storage unit 618 represents a floppy disk, magnetic tape, compact disk, DVD, optical storage disk, or any other computer data storage device. Removable storage drive 614 may read from and/or write to removable storage unit 618 in a well-known manner. According to an exemplary embodiment, secondary memory 610 may include similar means for allowing computer programs and/or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 also includes input/output/display devices 603, such as monitors, keyboards, pointing devices, etc., which communicate with communication infrastructure 606 through a display interface 602.

Computer system 600 further includes a communication or network interface 624. Communication interface 624 may enable computer system 600 to communicate with remote devices. For example, communication interface 624 may allow computer system 600 to communicate over communications path 626, such as LANs, WANs, the Internet, etc. Communications interface 624 may interface with remote sites or networks via wired or wireless connections.

Control logic may be transmitted to and from computer system 600 via communication path 626.

Any tangible apparatus or article of manufacture comprising a computer useable or readable medium having control logic (software) stored thereon is referred to herein as a computer program product or program storage device. This includes, but is not limited to, computer system 600, main memory 608, secondary storage device 610, and removable storage unit 618. Such computer program products, having control logic stored thereon that, when executed by one or more data processing devices, causes such data processing devices to operate as described herein, represent embodiments of the invention.

Embodiments can work with software, hardware, and/or operating system implementations other than those described herein. Any software, hardware, and operating system implementations suitable for performing the functions described herein can be used. Embodiments are applicable to both a client and to a server or a combination of both.

Embodiments may employ any computer useable or readable medium, known now or in the future. Examples of computer useable mediums include, but are not limited to, primary storage devices (e.g., random access memory), secondary storage devices (e.g., such as hard drives, floppy disks, CD ROMS, ZIP disks, tapes, magnetic storage devices, optical storage devices, MEMS, nanotechnological storage device, etc.), and communication mediums (e.g., such as wired and wireless communications networks, local area networks, wide area networks, intranets, etc.).

Reading this disclosure, it will become apparent to a person skilled in the relevant art how to implement these embodiments using other computer systems and/or computer architectures. Embodiments may further operate with software, hardware, and/or operating system implementations other than those described. Therefore, any software, hardware, and operating system implementations suitable for performing the functions described herein can be used.

It is also to be appreciated that the Detailed Description, and not the Summary and Abstract sections, is intended to be used to interpret the claims. The Summary and Abstract sections may set forth one or more but not all exemplary embodiments as contemplated by the inventor, and thus, are not intended be limiting in any way.

Various embodiments are described herein with the aid of functional building blocks for illustrating implementation of specified functions and relationships thereof. The boundaries of these functional building blocks have been arbitrarily defined for the convenience of the description. Alternate boundaries can be defined so long as the specified functions and relationships thereof are appropriately performed.

The foregoing description so fully reveals the general nature of the disclosed embodiments that others can, by applying knowledge within the ordinary skill of the art, readily modify and/or adapt for various applications such specific embodiments, without undue experimentation. Such adaptations and modifications are intended to be within the meaning and range of equivalents of the disclosed embodiments, based on the teaching and guidance presented herein.

It is to be understood that any phraseology or terminology is for the purpose of description and not of limitation, such that the terminology or phraseology of is to be interpreted by one of ordinary skill in the art in light of the teachings and guidance.

The breadth and scope of any of the disclosed embodiments should not be limited by any of the above-described exemplary embodiments, but should be defined only in accordance with the following claims and their equivalents.

What is claimed is:

1. A computer-implemented method for schedule synthesis, comprising:
defining a process model for a project plan;
performing quantitative analysis on the process model; and
synthesizing a schedule representation from the process model.

2. The computer-implemented method of claim 1, further comprising:
exporting the schedule representation to a project viewer.

3. The computer-implemented method of claim 1, further comprising:
generating one or more alternative project plans based on the quantitative analysis.

4. The computer-implemented method of claim 1, further comprising:
receiving one or more change inputs;
modifying the process model based on the change inputs;
performing quantitative analysis on the modified process model; and
synchronizing the modified process model and the schedule representation.

5. The computer-implemented method of claim 1, wherein the defining step comprises:
defining the process model by capturing parameters and process flow.

6. The computer-implemented method of claim 1, wherein the performing step comprises:
performing the quantitative analysis by performing queuing and stochastic analysis using a discrete event simulation engine.

7. The computer-implemented method of claim 1, wherein the synthesizing step comprises:
synthesizing the schedule representation using a discrete event simulation engine.

8. A system for schedule synthesis, comprising:
a project planning module configured to define a process model for a project plan;
a process modeling module configured to perform quantitative analysis on the process model; and
a schedule synthesis module configured to synthesize a schedule representation from the process model.

9. The system of claim 8, further comprising:
a project viewing module, implemented on a display device, configured to display the schedule representation in a user interface.

10. The system of claim 8, wherein the process modeling module is further configured to:
generate one or more alternative project plans based on the quantitative analysis.

11. The system of claim 8, wherein the process modeling module is further configured to:
receive one or more change inputs;
modify the process model based on the change inputs;
perform quantitative analysis on the modified process model; and
synchronize the modified process model and the schedule representation.

12. The system of claim 8, wherein the process modeling module is further configured to:
perform queuing and stochastic analysis on the process model using a discrete event simulation engine.

13. The system of claim 8, wherein the schedule synthesis module is further configured to:
synthesize the schedule representation using a discrete event simulation engine.

14. A computer-readable storage medium having control logic recorded thereon that, when executed by a processor, causes the processor to perform operations to synthesize a schedule, the operations comprising:
defining a process model for a project plan;
performing quantitative analysis on the process model; and
synthesizing a schedule representation from the process model.

15. The computer-readable storage medium of claim 14, the operations further comprising:
exporting the schedule representation to a project viewer.

16. The computer-readable storage medium of claim 14, the operations further comprising:
generating one or more alternative project plans based on the quantitative analysis.

17. The computer-readable storage medium of claim 14, the operations further comprising:
receiving one or more change inputs;
modifying the process model based on the change inputs;
performing quantitative analysis on the modified process model; and
synchronizing the modified process model and the schedule representation.

18. The computer-readable storage medium of claim 14, wherein the defining comprises:
defining the process model by capturing parameters and process flow.

19. The computer-readable storage medium of claim 14, wherein the performing comprises:
performing the quantitative analysis by performing queuing and stochastic analysis using a discrete event simulation engine.

20. The computer-readable storage medium of claim 14, wherein the synthesizing comprises:
synthesizing the schedule representation using a discrete event simulation engine.
